(19) United States
(12) Patent Application Publication
(10) Pub. No.: US 2008/0117137 A1
(43) Pub. Date: May 22, 2008

(54) Plasma display and driving method thereof

(76) Inventor: Myoung-Kwan Kim, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/986,080

(22) Filed: Nov. 19, 2007

(30) Foreign Application Priority Data
Nov. 20, 2006 (KR) 10-2006-0114693

(51) Int. Cl. G09G 3/28

(52) U.S. Cl. 345/60

(57) ABSTRACT

A plasma display and a driving method thereof are disclosed. The plasma display includes a plurality of address electrodes; an address electrode driver that includes at least one power recovering capacitor and a plurality of address driving circuits having a plurality of first switches controlling current paths between the power recovering capacitor and the address electrodes. The driver circuit turns on the first switch during a first period of when the voltage of the address electrode is changed from a first voltage to a second voltage and during a second period of when the voltage of the address electrode is changed from the second voltage to the first voltage. The display also has a controller that divides one field into a plurality of subfields each having a weight value and controls the duration of at least one of the first period and the second period according to the weight value of each subfield.

### CROSS-REFERENCE TO RELATED APPLICATION

This application claims priority to and the benefit of Korean Patent Application No. 10-2006-0114693 filed in the Korean Intellectual Property Office on Nov. 20, 2006, the entire contents of which are incorporated herein by reference.

### BACKGROUND

1. Field

The field relates to a plasma display and a method of driving the same.

2. Description of the Related Technology

Plasma displays are flat display devices that display text or images using plasma generated by gas discharge. A plasma display panel of a plasma display includes hundreds of thousands to millions of discharge cells (hereinafter, referred to as “cells”) or more, which are arranged in a matrix, according to the size of the plasma display panel.

The plasma display divides one frame into a plurality of subfields each having a weight value and time-divisionally controls the subfields to realize grayscale display. During an address period of each subfield, a scan pulse is sequentially applied to a plurality of scan electrodes and an address pulse is selectively applied to a plurality of address electrodes. In a cell to which both the scan pulse and the address pulse are simultaneously applied, address discharge occurs.

Meanwhile, during the address period, since a discharge space between the address electrode and the scan electrode serves as a capacitor, a capacitance component exists in the panel. Therefore, in order to apply the address pulse to the address electrodes, both power for address discharge and reactive power for the capacitance are needed. In order to recover and reuse reactive power generated when the address pulse is applied to the address electrodes, a capacitor for power recovery is used to charge or discharge the panel capacitor. In this case, if the time it takes to charge or discharge the panel capacitor is short, the power recovery efficiency is reduced, and if the time it takes to charge or discharge the panel capacitor is long, the address pulse width is reduced, resulting in erroneous address discharge.

The above information disclosed in this Background section is only for enhancement of understanding of the background of the invention and therefore may contain information that does not form the prior art that is already known in this country to a person of ordinary skill in the art.

### SUMMARY OF CERTAIN INVENTIVE ASPECTS

One aspect is a plasma display including a plurality of address electrodes, an address electrode driver, including at least one power recovering capacitor and a plurality of address driving circuits having a plurality of first switches configured to control current paths between the power recovering capacitor and the address electrodes to turn on one or more of the first switches during a first period when a voltage of the address electrode is changed from a first voltage to a second voltage and during a second period when the voltage of the address electrode is changed from the second voltage to the first voltage, and a controller configured to divide one field into a plurality of subfields each having a weight value and to control at least one of the first period and the second period according to the weight value of each subfield.

Another aspect is a plasma display including a plurality of address electrodes, a plurality of first switches respectively coupled between the plurality of address electrodes and a first power supply configured to supply a first voltage, a plurality of second switches respectively coupled between the plurality of address electrodes and a second power supply configured to supply a second voltage, the second voltage being lower than the first voltage, a power recovery capacitor, a plurality of third switches respectively coupled between the power recovery capacitor and the plurality of address electrodes, and a controller configured to divide each field into a plurality of subfields having respective weight values and to adjust a turn-on period of at least one of the plurality of third switches according to the weight value of each subfield.

Another aspect is a driving method of a plasma display, the display including a power recovery capacitor, a plurality of address electrodes, and a plurality of switches coupled between the power recovery capacitor and the plurality of address electrodes, where one field is divided into a plurality of subfields. The method includes turning on at least one first switch among the plurality of switches so as to increase a voltage of a first address electrode, the first address electrode corresponding to the at least one first switch, applying a first voltage to the first address electrode, turning on at least one second switch among the plurality of switches so as to decrease a voltage of a second address electrode, the second address electrode corresponding to the at least one second switch, applying a second voltage to the second address electrode, the second voltage lower than the first voltage, and adjusting a turn-on period of the at least one first switch or the at least one second switch according to a weight value of each subfield.

### BRIEF DESCRIPTION OF THE DRAWINGS

FIG. 1 is a plan view illustrating a plasma display according to an embodiment.

FIG. 2 is a view illustrating an address driving circuit according to an embodiment.

FIG. 3 is a view illustrating a signal timing of an address driving circuit for generating a driving waveform applied to an address electrode.

FIGS. 4A to 4D are schematic views each illustrating an address power recovering operation of the address driving circuit shown in FIG. 2.

FIGS. 5A and 5B are timing views each illustrating an address driving waveform according to the turn-on period of the power recovering switch S3.

FIG. 6 is a timing view illustrating the relationship of the turn-on period of switch S3 and a weight value with respect to time.

### DETAILED DESCRIPTION OF CERTAIN INVENTIVE EMBODIMENTS

In the following detailed description, only certain embodiments are shown and described, simply by way of illustration. As those skilled in the art would realize, the described embodiments may be modified in various ways, without departing from the spirit or scope of the present invention. Accordingly, the drawings and description are to be regarded as illustrative in nature and not restrictive. Like reference numerals generally designate like elements throughout the specification. It will be understood that when an element or layer is referred to as being “connected to” or “coupled to” another element or layer, it can be directly connected or coupled to the other element or layer or intervening elements or layers may be present.

Throughout this specification and the claims that follow, when it is described that an element is “coupled” to another element, the element may be “mechanically coupled” to the other element or “electrically coupled” to the other element. In addition, unless explicitly described to the contrary, the word “comprise” and variations such as “comprises” or “comprising”, will be understood to imply the inclusion of stated elements but not the exclusion of any other elements.

A plasma display and a method of driving the same according to certain embodiments of the present invention will be described.

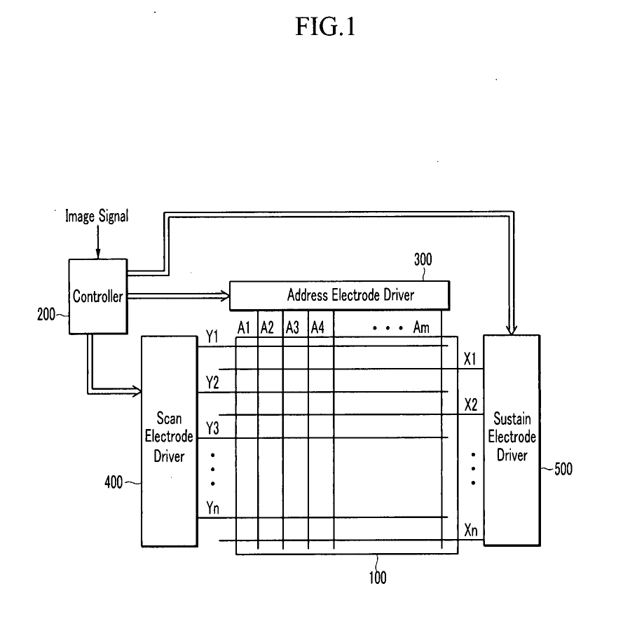

FIG. 1 is a plan view schematically illustrating a plasma display according to some embodiments.

As shown in FIG. 1, the plasma display includes a plasma display panel 100, a controller 200, an address electrode driver 300, a scan electrode driver 400, and a sustain electrode driver 500.

The plasma display panel 100 includes a plurality of address electrodes A1 to Am that extend in a vertical direction, and a plurality of sustain electrodes X1 to Xn and a plurality of scan electrodes Y1 to Yn that extend in a horizontal direction, the sustain and scan electrodes forming related pairs. The sustain electrodes X1 to Xn are formed to correspond to the scan electrodes Y1 to Yn such that discharge spaces are formed at intersections of the address electrodes A1 to Am, and the pairs of related sustain electrodes X1 to Xn and scan electrodes Y1 to Yn. The structure of the plasma display panel 100 is illustrative, and panels having different structures, to which a driving waveform, which will be described below, can be used.

When receiving an image signal from the outside, the controller 200 outputs an address electrode driving control signal, a sustain electrode driving control signal, and a scan electrode driving control signal. The controller 200 drives such that each frame which is divided into a plurality of subfields and grayscale display is realized by combining various time-weight values of the subfields.

When receiving the address electrode driving control signal from the controller 200, during the address period, the address electrode driver 300 selectively applies an address pulse to the plurality of address electrodes A1 to Am of the cells selected to be turned on and of the cells selected to not be turned on. In addition, the controller 200 adjusts, according to the weight values of the subfields, a turn-on duration of a control switch such that a capacitor for power recovery either recovers power or discharges power during the address period.

When receiving the scan electrode driving control signal from the controller 200, the scan electrode driver 400 applies a driving voltage to the scan electrodes Y1 to Yn. Particularly, the scan electrode driver 400 selectively applies a scan pulse to the plurality of scan electrodes Y1 to Yn during the address period. For example, the scan electrode driver 400 may sequentially apply a scan pulse to the plurality of scan electrodes Y1 to Yn in the order of the arrangement of the plurality of scan electrodes in a column direction.

According to the received sustain electrode driving control signal from the controller 200, the sustain electrode driver 500 applies a driving voltage to the sustain electrodes.

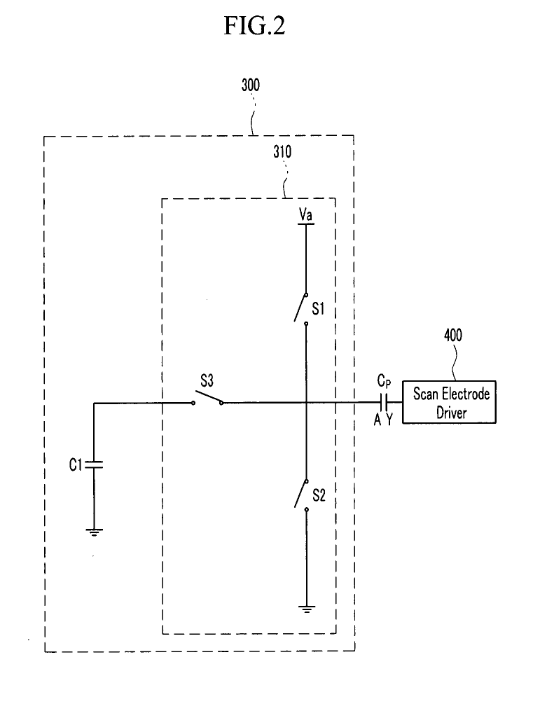

An address driving circuit included in the address electrode driver 300 will be described in detail with reference to FIG. 2.

FIG. 2 is a view illustrating an address electrode driver 300 according to some embodiments.

As shown in FIG. 2, the address electrode driver 300 includes at least one power recovering capacitor C1, and a plurality of address driving circuits 310 connected to the plurality of address electrodes A (corresponding to reference symbols A1 to Am in FIG. 1), respectively.

For ease of explanation, in FIG. 2, only a single address driving circuit 310 connected to one address electrode A is illustrated and a capacitive component formed by the address electrode A and the scan electrode Y is shown as the panel capacitor Cp. Among the plurality of address driving circuits 310, the predetermined number of address driving circuits 310 may be integrated into an integrated circuit (IC). The integrated circuit may be mounted on a packaging connection member, such as a tape carrier package (TCP), for example, in a chip. The packaging connection member may be bonded to the plasma display panel 100 and a printed circuit board (not shown) of the address electrode driver 300. In this case, the power recovering capacitor C1 may be mounted in the printed circuit board and be connected to the integrated circuit of the packaging connection member.

Also, at least one power recovering capacitor C1 may be commonly connected to the plurality of address driving circuits 310. Alternatively, separate power recovering capacitors C1 may be connected to each of the address driving circuits (for example, an integrated circuit including address driving circuits). In some embodiments, the size of the power recovering capacitor C1 is larger than the panel capacitor Cp and thus variation in the voltage of the power recovering capacitor C1 due to a current charged to or discharged from the panel capacitor Cp when a switch S3 is turned on is small. Further, in some embodiments, the power recovering capacitor C1 supplies a voltage between an address voltage Va and a voltage of 0V, particularly, about half the amount of the address voltage.

The address driving circuit 310 includes a driving switch S1, a grounding switch S2, and a power recovering switch S3.

A first terminal of driving switch S1 is connected to a power supply supplying the address voltage Va and a second terminal is connected to the address electrode A. When the driving switch S1 is turned on, the address voltage Va is applied to the address electrode A. In the grounding switch S2, a first terminal is connected to the address electrode A and a second terminal is connected to a power supply supplying a reference voltage (a ground terminal in FIG. 2). When the grounding switch S2 is turned on, a ground voltage 0V is applied to the address electrode A. In the power recovering switch S3, a first terminal is connected to the capacitor C1 and a second terminal is connected to the address electrode A.

In FIG. 2, a field effect transistor may be used as each of switches S1, S2, and S3, or different switches having the same or similar function may be used as the switches S1, S3, and S3. Also, when transistors with a body diode are used as the switches S1, S2, and S3, the switch S3 may be formed of a back-to-back transistor to block a path through which the power recovering capacitor C1 is charged or discharged due to the body diodes.

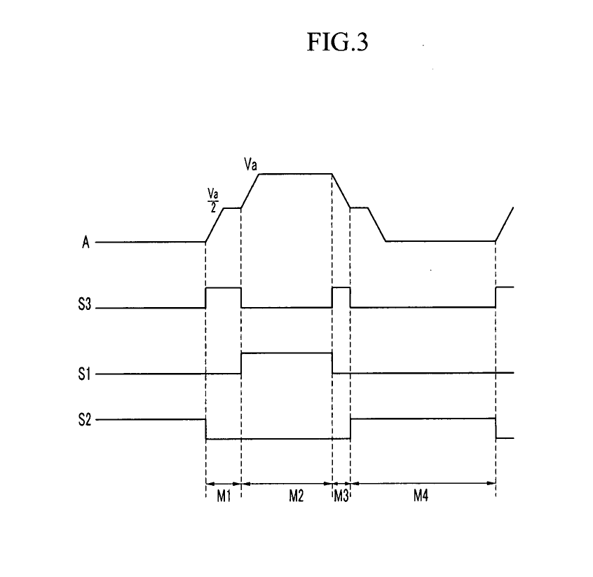

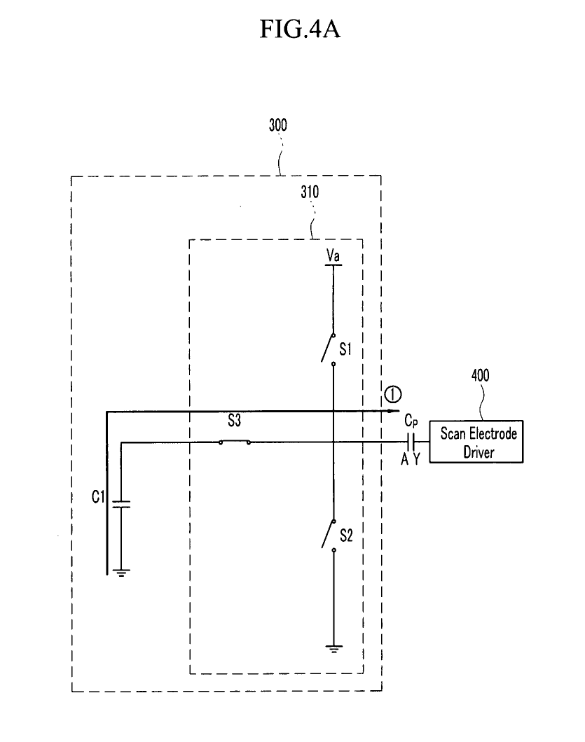

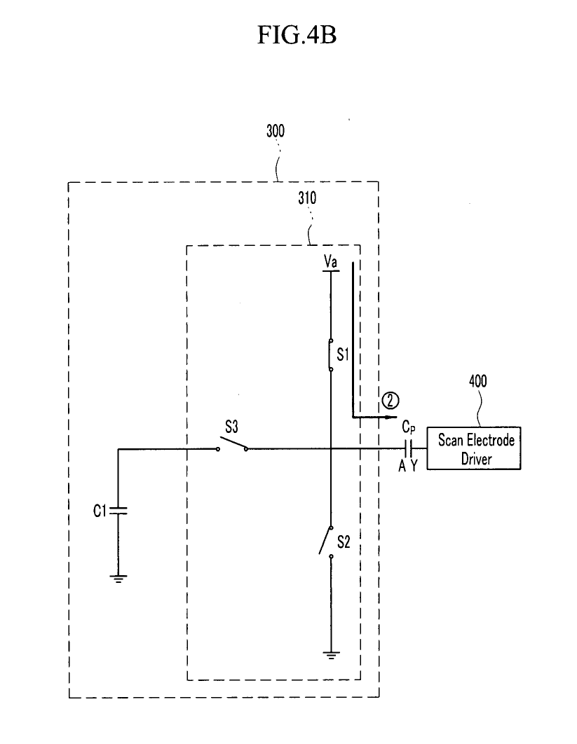

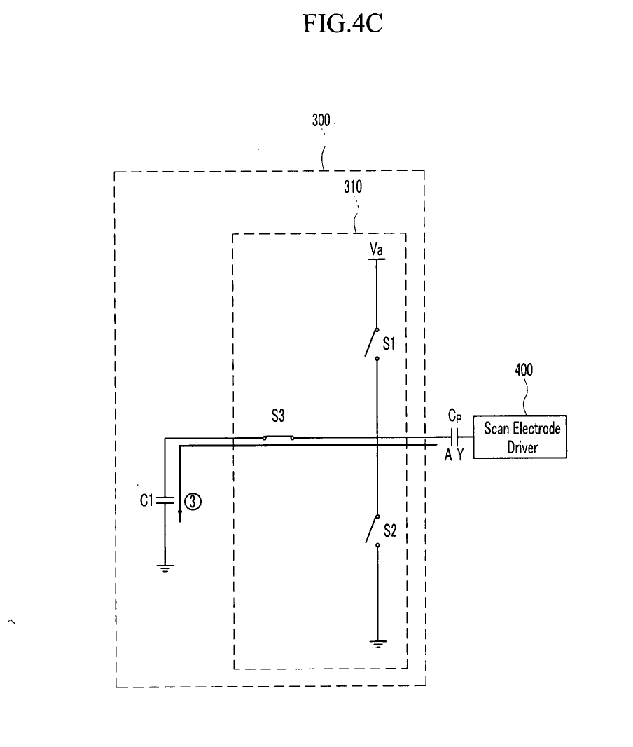

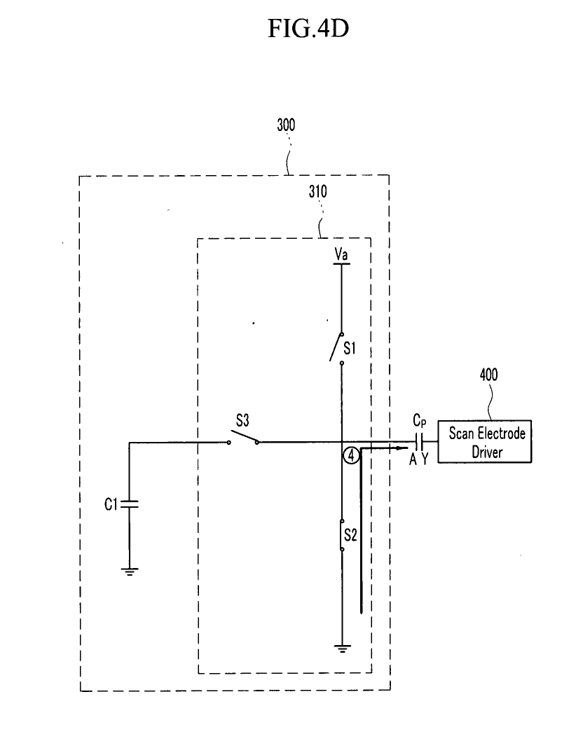

Next, the operation of the address electrode driver 300 shown in FIG. 2 will be described with reference to FIGS. 3 and 4A to 4D.

FIG. 3 is a view illustrating a signal timing of the address electrode driver 300. FIGS. 4A to 4D are views illustrating the operation of the address electrode driver 300 shown in FIG. 2.

In FIG. 3, the grounding switch S2 is turned on before a first step M1 starts, and thus the ground voltage 0V is applied to the address electrode A.

Referring to FIG. 3 and FIG. 4A, in the first step M1, the grounding switch S2 is turned off and the switch S3 is turned on. Then, as shown in FIG. 4A, a voltage charged in the power recovering capacitor C1 directly charges the panel capacitor Cp through a path \textcircled{1} from the power recovering capacitor C1 to the panel capacitor Cp through the switch S3. As a result, the voltage of the address electrode A increases from 0V to about the stored voltage of the power recovering capacitor C1.

In some embodiments, the voltage of the address electrode A is determined by the turn-on period of the switch S3. As described above, assuming that about half the amount of the address voltage Va, that is, a voltage of Va/2 is stored in the capacitor C1 and the capacitance of the capacitor C1 is large compared to the capacitance of the panel capacitor Cp, the voltage of the address electrode A can increase to about half the amount of the address voltage Va, that is, a voltage of Va/2.

When the voltage of the capacitor C1 charges the panel capacitor Cp, it is possible to reduce the time it takes to charge or discharge the panel capacitor Cp, as compared to a case of using resonance of an external inductor and a panel capacitor to charge the panel capacitor Cp.

Next, in a second step M2, the switch S3 is turned off and the driving switch S1 is turned on. Then, as shown in FIG. 4B, the address voltage Va is applied to the address electrode A of the panel capacitor through a path \textcircled{2} from the power supply Va to the panel capacitor Cp through the driving switch S1. Thus, the panel capacitor Cp has been charged from the ground voltage to the address voltage Va with only about half of the charge coming from the power supply Va, the other half being supplied by the capacitor C1.

Subsequently, in a third step M3, the driving switch S1 is turned off and the switch S3 is turned on. Then, as shown in FIG. 4C, the charged voltage of the panel capacitor Cp is recovered by the power recovering capacitor through a path \textcircled{3} from the panel capacitor Cp to the power recovering capacitor C1 through the switch S3. As a result, the voltage of the address electrode A decreases from the address voltage Va to about half of the address voltage Va.

In a fourth step M4, the switch S3 is turned off and the grounding switch S2 is turned on. Then, as shown in FIG. 4D, a voltage of 0V is applied to the address electrode A of the panel capacitor Cp through a path \textcircled{4} from a ground source to the panel capacitor Cp through the grounding switch S2. Thus, the panel capacitor Cp has been discharged from the address voltage Va to the ground voltage of 0V with only about half of the charge going to the ground source, the other half going to the capacitor C1.

The above-mentioned operations in the first to fourth steps M1 to M4 are performed when data (hereinafter, address data) applied to the address electrode A is changed. For example, one or more of the operations of the first to fourth steps M1 to M4 can be performed to apply a voltage of 0V to the address electrode A during a period when the scan pulse is applied to the scan electrode Y (corresponding to reference symbol Y1 in FIG. 1), to apply the address voltage Va to the address electrode A during a period when the scan pulse is applied to another scan electrode (for example, corresponding to reference symbol Y2 in FIG. 1), and/or to apply a voltage of 0V to the address electrode A during a period when the scan pulse is applied to a third scan electrode (for example, corresponding to reference symbol Y3 in FIG. 1) (such as the fourth step M4 of FIG. 2). However, when the address voltage Va is applied to the address electrode A during the periods of when the scan pulse is applied to the second and third scan electrodes (such as the reference symbols Y2 and Y3 in FIG. 1), the address voltage Va may continue to be applied to the address electrode A without decreasing the voltage of the address electrode A. Similarly, when a voltage of 0V is applied to the address electrode A during the periods of when the scan pulse is applied to the first and second scan electrodes (such as the reference symbols Y1 and Y2 in FIG. 1), the voltage of 0V may continue to be applied to the address electrode A without increasing the voltage of the address electrode A.

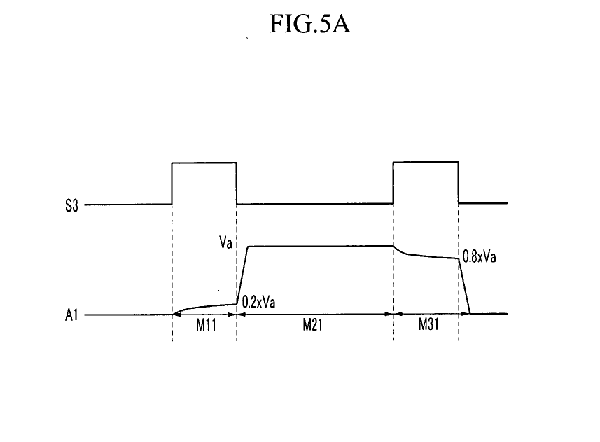

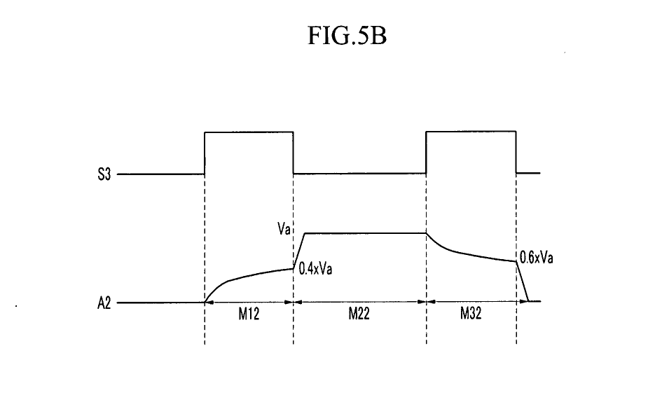

Next, erroneous address discharge and efficiency of the address power consumption according to the turn-on period (the periods corresponding to the first step M1 and the third step M3 in FIG. 3) of the power recovering switch shown in FIG. 2 will be described with reference to FIGS. 5A and 5B.

FIGS. 5A and 5B are views each illustrating an address driving waveform according to the turn-on period of the power recovering switch S3.

As shown in FIG. 5A, when increasing the voltage of the address electrode A, if a turn-on period M11 of the switch S3 is short, the voltage of the address electrode A increases to a voltage, for example, a 0.2*Va voltage, which is lower than half the amount of the address voltage Va. Similarly, if a turn-on period M31 of the switch S3 when decreasing the voltage of the address electrode A is short, the voltage of the address electrode decreases to a voltage higher than half the amount of the address voltage Va, for example, 0.8*Va voltage. Therefore, the time it takes to change the voltage of the address electrode A is short. In this case, when the address voltage Va is applied to the address electrode A, if a turn-on period M21 of the switch S3 is sufficient, it is possible to stably perform the address discharge. However, since the amount of charges moving into the power recovering capacitor C1 is small, the power recovery efficiency decreases.

In contrast, as shown in FIG. 5B, when increasing the voltage of the address electrode A, if the turn-on period M12 of the switch S3 is long, the voltage of the address electrode A increases to a voltage higher than the decreased voltage (e.g., 0.2*Va voltage), for example, to a 0.4*Va voltage. Similarly, when decreasing the voltage of the address electrode A, if the turn-on period M32 of the switch S3 is long, the voltage of the address electrode A decreases to a voltage lower than the increased voltage (e.g., 0.8*Va voltage), for example, to 0.6*Va voltage. In this case, the time for changing the voltage of the address electrode A is long, and thus, the amount of charges moving into the power recovering capacitor C1 is large. Therefore, the power recovery efficiency increases. However, the period M22 for which the Va voltage is applied to the address period A is shortened, and accordingly, the address discharge may become unstable.

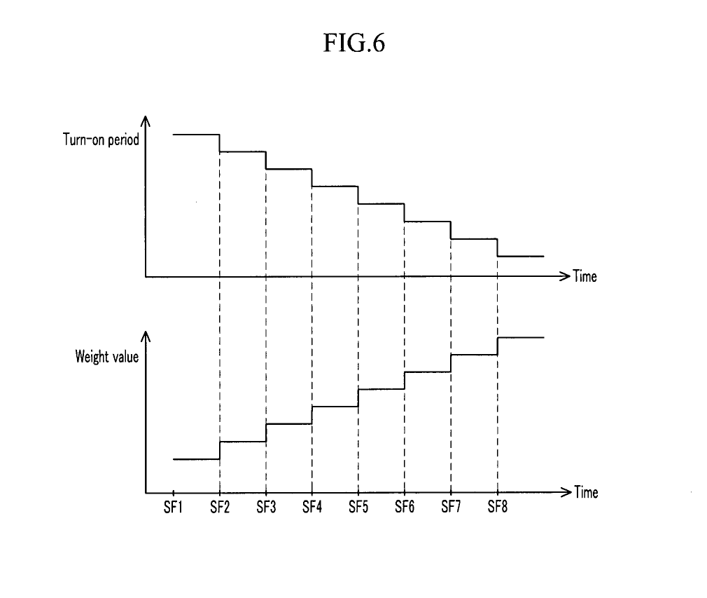

Therefore, according to an embodiment shown in FIG. 6, one field is divided into the plurality of subfields each having a weight value and the turn-on period of the power recovering switch (S3 in FIG. 3) is adjusted according to the weight value of each subfield. In FIG. 6, one field is divided into eight subfields SF1 to SF8, and the weight value increases from the first subfield SF1 to the eighth subfield SF8. That is, the weight value of the first subfield SF1 is smallest, and the weight value of the eighth subfield SF8 is largest.

More specifically, since grayscales of adjacent cells in the row direction are similar (that is, difference in grayscales thereof is very small), the amount of variation in the address data is large for the subfield having a small weight value. As such, in the subfield having a small weight value, the power recovering operation frequently occurs since the address electrode A frequently alternates between Va and 0 voltages. Therefore, according to the controller 200 of some embodiments, the turn-on period of the power recovering switch S3 is set to be long enough in the subfield having a small weight value, so as to increase the power recovering efficiency.

In the subfield having a large weight value, the amount of variation in the address data is small and thus the power recovering operation does not frequently occur. Therefore, in a subfield having a large weight value, the turn-on period of the power recovering switch S3 is shortened.

As described above, according some embodiments, it is possible to stably perform the address discharge operation while improving the efficiency of the address power consumption by adjusting the pulse width of the switch S3.

While certain embodiments have been described in connection with what is presently considered to be practical implementations, it is to be understood that the invention is not limited to the disclosed embodiments, but, on the contrary, is intended to cover various modifications and equivalent arrangements included within the spirit and scope of the appended claims.

What is claimed is:

1. A plasma display comprising:
a plurality of address electrodes;
an address electrode driver, comprising:
at least one power recovering capacitor; and
a plurality of address driving circuits having a plurality of first switches configured to control current paths between the power recovering capacitor and the address electrodes to turn on one or more of the first switches during a first period when a voltage of the address electrode is changed from a first voltage to a second voltage and during a second period when the voltage of the address electrode is changed from the second voltage to the first voltage; and
a controller configured to divide one field into a plurality of subfields each having a weight value and to control at least one of the first period and the second period according to the weight value of each subfield.

2. The plasma display of claim 1, wherein the address driving circuit is formed as an integrated circuit.

3. The plasma display of claim 1, further comprising:
a packaging connection member that connects the address electrodes and the power recovering capacitor,
wherein the address driving circuit is mounted to the packaging connection member.

4. The plasma display of claim 3, wherein the packaging connection member includes a tape carrier package.

5. The plasma display of claim 1, wherein the controller sets at least one of the first and second periods of a first subfield to be larger than at least one of the first and second periods of a second subfield, the second subfield having a weight value larger than the first subfield.

6. The plasma display of claim 1, wherein the address driving circuit further includes:
a second switch coupled between the address electrode and a first power supply configured to supply the first voltage; and
a third switch coupled between the address electrode and a second power supply configured to supply the second voltage.

7. A plasma display comprising:
a plurality of address electrodes;
a plurality of first switches respectively coupled between the plurality of address electrodes and a first power supply configured to supply a first voltage;
a plurality of second switches respectively coupled between the plurality of address electrodes and a second power supply configured to supply a second voltage, the second voltage being lower than the first voltage;
a power recovery capacitor;
a plurality of third switches respectively coupled between the power recovery capacitor and the plurality of address electrodes; and
a controller configured to divide each field into a plurality of subfields having respective weight values and to adjust a turn-on period of at least one of the plurality of third switches according to the weight value of each subfield.

8. The plasma display of claim 7, wherein the controller is configured to set at least one of the first and second periods of a first subfield to be longer than at least one of the first and second periods of a second subfield, the second subfield having a weight value higher than the first subfield.

9. The plasma display of claim 7, configured to turn on at least one of the plurality of third switches, to either increase the voltage of an address electrode from the second voltage to a voltage lower than a third voltage or to decrease the voltage of an address electrode from the first voltage to a voltage higher than the third voltage, the third voltage being about the average of the first and second voltages.

10. The plasma display of claim 7, wherein the controller is configured to turn on at least one of the third switches so as to discharge one of the address electrodes to the voltage on the power recovery capacitor when the address electrode has a voltage higher than the voltage on the voltage recovery capacitor and to charge the one of the address electrodes to the voltage on the power recovery capacitor when the address electrode has a voltage lower than the voltage on the voltage recovery capacitor.

11. The plasma display of claim 10, wherein the controller is further configured to turn on at least one of the first switches so as to discharge the one address electrode to the second voltage and to turn on at least one of the second switches to charge the one address electrode to the first voltage.

12. A driving method of a plasma display, the display including a power recovery capacitor, a plurality of address electrodes, and a plurality of switches coupled between the power recovery capacitor and the plurality of address electrodes, wherein one field is divided into a plurality of subfields, the method comprising:
turning on at least one first switch among the plurality of switches so as to increase a voltage of a first address electrode, the first address electrode corresponding to the at least one first switch;
applying a first voltage to the first address electrode;
turning on at least one second switch among the plurality of switches so as to decrease a voltage of a second address electrode, the second address electrode corresponding to the at least one second switch;
applying a second voltage to the second address electrode, the second voltage lower than the first voltage; and
adjusting a turn-on period of the at least one first switch or the at least one second switch according to a weight value of each subfield.

13. The method of claim 12, wherein the adjusting of the turn-on period comprises adjusting the turn-on period of the at least one first switch in the first subfield to be longer than in a second subfield having a weight value larger than the first subfield.

14. The method of claim 12, wherein the adjusting of the turn-on period comprises adjusting the turn-on period of the at least one second switch in the first subfield to be longer than in a second subfield having a weight value larger than the first subfield.

15. The method of claim 12, wherein increasing the voltage of the first address electrode comprises increasing the voltage from a starting voltage to a voltage about equal to the average of the starting voltage and the first voltage.

16. The method of claim 12, wherein decreasing the voltage of the second address electrode comprises decreasing the voltage from a starting voltage to a voltage about equal to the average of the starting voltage and the second voltage.

17. The method of claim 12, wherein the voltage of the first address electrode is increased to a voltage about the same as the voltage to which the second address electrode is decreased.

18. The method of claim 12, wherein the second voltage is substantially a ground voltage.

19. The method of claim 12, wherein the display further comprises a plurality of power supply switches, and the method further comprises turning on at least one third switch among the plurality of power supply switches so as to increase the voltage of the first address electrode to the first voltage.

20. The method of claim 12, wherein the display further comprises a plurality of power supply switches, and the method further comprises turning on at least one third switch among the plurality of power supply switches so as to decrease the voltage of the second address electrode to the second voltage.
